(19) United States
(12) Patent Application Publication
(10) Pub. No.: US 2026/0341942 A1
(43) Pub. Date: Oct. 29, 2026

(54) SYSTEM FOR REMOVING ELECTROLYTE FROM A BATTERY

(71) Applicant: GM GLOBAL TECHNOLOGY OPERATIONS LLC, Detroit, MI (US)

(72) Inventors: Daniel RYAN, Fenton, MI (US); Jennifer Therese BRACEY, Holly, MI (US); Andrew Clay BOBEL, Troy, MI (US); Nicole ELLISON, Southfield, MI (US); John Patrick SPICER, Plymouth, MI (US)

(21) Appl. No.: 19/191,483

(22) Filed: Apr. 28, 2025

(51) Int. Cl. H01M 50/691

(52) U.S. Cl. CPC H01M 50/691

(57) ABSTRACT

A system configured to remove an electrolyte from a battery. The system includes: a rotatable platform; a battery support configured to be rotated by the rotatable platform; a motor configured to rotate the rotatable platform; an impalement device adjacent to the battery support, the impalement device configured to puncture the battery seated on the battery support as the rotatable platform rotates to drain the electrolyte out of the battery by centrifugal force; a reservoir configured to collect the electrolyte; and a conduit in fluid communication with the impalement device and the reservoir to direct the electrolyte from the impalement device to the reservoir.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to a system for removing electrolyte from a battery.

An electrolyte of a battery is a chemical medium that allows ions to move between electrodes of the battery during charging and discharging. The electrolyte is a liquid, gel, or solid, for example. The electrolyte completes the circuit inside the battery by enabling the internal flow of ions. Battery recycling includes separating the electrolyte from the rest of the battery and processing the electrolyte for potential future use.

### SUMMARY

The present disclosure is directed to a system configured to remove an electrolyte from a battery. The system includes: a rotatable platform; a battery support configured to be rotated by the rotatable platform; a motor configured to rotate the rotatable platform; an impalement device adjacent to the battery support, the impalement device configured to puncture the battery seated on the battery support as the rotatable platform rotates to drain the electrolyte out of the battery by centrifugal force; a reservoir configured to collect the electrolyte; and a conduit in fluid communication with the impalement device and the reservoir to direct the electrolyte from the impalement device to the reservoir.

In further features, the impalement device is a first impalement device, the system further comprising a second impalement device adjacent to the battery support and configured to puncture the battery seated on the battery support; and the first impalement device and the second impalement device are configured to puncture opposite sides of the battery seated on the battery support.

In further features, the rotatable platform includes a housing defining a receptacle, the battery support is within the receptacle; and the system further includes a lid configured to cooperate with the housing to cover and seal the receptacle, the lid defining a gas inlet configured to direct gas into the receptacle.

In further features, the first impalement device is outboard of the second impalement device such that the second impalement device is closer to an axial center of the rotatable platform than the first impalement device; the first impalement device is configured to puncture a first end of the battery and the second impalement device configured to puncture a second end of the battery that is opposite to the first end; and gas within the receptacle is free to flow into the battery through the second end of the battery when punctured by the second impalement device.

In further features, the battery support is one of a plurality of battery supports spaced apart in a circle around an axis of rotation of the rotatable platform.

In further features, the impalement device is one of a plurality of impalement devices each adjacent to a different one of the plurality of battery supports, each one of the plurality of impalement devices is configured to drain the electrolyte out of batteries seated in the plurality of battery supports; and the conduit includes a plurality of conduits in fluid communication with the plurality of impalement devices to direct the electrolyte from the plurality of impalement devices to the reservoir.

In further features, the battery support is configured to support one of a cylindrical battery cell and a prismatic battery cell.

In further features, the impalement device includes a piercing tip; and the battery support is configured to permit centrifugal force generated by rotation of the rotatable platform to move the battery into contact with the piercing tip such that the piercing tip punctures the battery.

In further features, the piercing tip defines a channel in fluid communication with the conduit, an opening of the channel is configured to enter the battery when the piercing tip punctures the battery, the electrolyte flows through the channel of the piercing tip and into the conduit in response to centrifugal force generated as the rotatable platform rotates.

In further features, the impalement device includes a piercing tip defining a channel in fluid communication with the reservoir by way of the conduit; the impalement device includes an actuator configured to move the piercing tip into the battery to puncture the battery and drain the electrolyte out of the battery into the reservoir; and the actuator is configured as one of an electric actuator and a pneumatic actuator.

In further features, the battery support is configured to support the battery at an angle such that a distal end of the battery is tilted downward relative to a proximal end of the battery.

The present disclosure also provides for, in various features, a system configured to remove an electrolyte from a battery, the system including: a rotatable platform configured to rotate about an axis of rotation; a battery support configured to be rotated by the rotatable platform; a motor configured to rotate the rotatable platform; an outboard impalement device adjacent to the battery support, the outboard impalement device configured to puncture an outboard end of the battery seated on the battery support as the rotatable platform rotates to drain the electrolyte out of the battery by centrifugal force; an inboard impalement device opposite to the outboard impalement device, the battery support configured to support the battery between the outboard impalement device and the inboard impalement device, the inboard impalement device configured to puncture an inboard end of the battery as the rotatable platform rotates to vent the battery, the inboard impalement device is closer to the axis of rotation than the outboard impalement device; a reservoir configured to collect the electrolyte; and a conduit in fluid communication with the outboard impalement device and the reservoir to direct the electrolyte from the outboard impalement device to the reservoir.

In further features, the rotatable platform includes a housing defining a receptacle, the battery support is within the receptacle; the system further includes a lid configured to cooperate with the housing to cover and seal the receptacle, the lid defining a gas inlet configured to direct inert gas into the receptacle; and inert gas within the receptacle is free to flow into the battery through the outboard end of the battery when punctured by the inboard impalement device.

In further features, the battery support is one of a plurality of battery supports arranged in a circle around the axis of rotation of the rotatable platform; and the outboard impalement device is one of a plurality of outboard impalement devices and the inboard impalement device is one of a plurality of inboard impalement devices, each one of the battery supports is arranged between one of the plurality of outboard impalement devices and one of the plurality of inboard impalement devices.

In further features, the battery support is configured to support one of a cylindrical battery cell and a prismatic battery cell.

In further features, the outboard impalement device includes a piercing tip defining a channel in fluid communication with the reservoir by way of the conduit; the outboard impalement device includes an actuator configured to move the piercing tip into the battery to puncture the outboard end of the battery and drain the electrolyte out of the battery into the reservoir; and the actuator is configured as one of an electric actuator and a pneumatic actuator.

In further features, the battery support is configured to support the battery at an angle such that the outboard end of the battery is tilted downward relative to the inboard end of the battery.

The present disclosure also provides for a system configured to remove electrolytes from a plurality of batteries, the system includes: a rotatable platform configured to rotate about an axis of rotation; a motor configured to rotate the rotatable platform; a plurality of outboard impalement devices mounted to the rotatable platform and spaced apart around the axis of rotation, each one of the plurality of outboard impalement devices configured to puncture an outboard end one of the plurality of batteries as the rotatable platform rotates to drain the electrolyte out of the battery by centrifugal force; a plurality of inboard impalement devices mounted to the rotatable platform and spaced apart around the axis of rotation, each one of the plurality of inboard impalement devices is opposite to a different one of the plurality of outboard impalement devices, each one of the plurality of inboard impalement devices is configured to puncture an inboard end one of the plurality of batteries to vent the plurality of batteries; a reservoir configured to collect the electrolytes from each one of the plurality of batteries; and a conduit system in fluid communication with each one of the outboard impalement devices and the reservoir to direct the electrolytes into the reservoir.

In further features, each one of the outboard impalement devices includes a pointed tip configured to puncture the outboard end of the plurality of batteries, the pointed tip defines a channel in fluid communication with the conduit system to direct the electrolytes through the pointed tip and into the conduit system.

In further features, the rotatable platform includes a housing defining a receptacle, each one of the plurality of outboard impalement devices and each one of the plurality of inboard impalement devices are within the receptacle; and the system further includes a lid configured to cooperate with the housing to cover and seal the receptacle, the lid defining a gas inlet configured to direct inert gas into the receptacle.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 illustrates a system in accordance with the present disclosure for removing an electrolyte from a battery;

FIG. 2 is a top view of the system of FIG. 1 including a plurality of exemplary batteries, the system configured to drain the batteries of their electrolytes;

FIG. 3A is a side view of an exemplary first impalement device and an exemplary second impalement device in accordance with the present disclosure with an exemplary battery therebetween, the impalement devices are configured to puncture the battery to drain the electrolyte therefrom, FIG. 3A illustrates positions of the first and second impalement devices prior to rotation of a rotatable platform of the system of FIG. 1;

FIG. 3B is a side view similar to FIG. 3A, but illustrates tips of the first and second impalement devices having punctured the battery during rotation of the rotatable platform;

FIG. 4 is a side view of an additional impalement device in accordance with the present disclosure;

FIG. 5 is a side view of another impalement device in accordance with the present disclosure; and

FIG. 6 is a side view of exemplary battery support devices of the present disclosure.

In the drawings, reference numbers may be reused to identify similar and/or identical elements.

### DETAILED DESCRIPTION

The present disclosure includes systems and methods configured to remove an electrolyte from a battery, or a plurality of batteries simultaneously. The present disclosure includes use of centrifugal force to drain batteries of their electrolytes through holes punctured in the batteries while the batteries are spun on a rotatable platform at high speed, such as at 200 revolutions per minute (RPM), for example. The electrolytes are drained into a single reservoir, which facilitates recycling and/or disposal of the electrolyte, as well as any byproducts drained along with the electrolyte.

The present disclosure provides an efficient battery recycling system, which removes electrolyte from a plurality of batteries simultaneously at a rapid rate while keeping a majority of each battery intact to permit analysis of battery performance and facilitate recycling. The systems and methods of the present disclosure eliminate any need to cut an entirety of (or at least a majority of) a battery open while the battery is held stationary, which can be a troublesome and time-consuming process resulting in a very slow drainage of electrolyte. The disclosure also eliminates any need to shred the contents of a battery during recycling, which requires additional recycling processes and makes it difficult to examine the battery for research purposes.

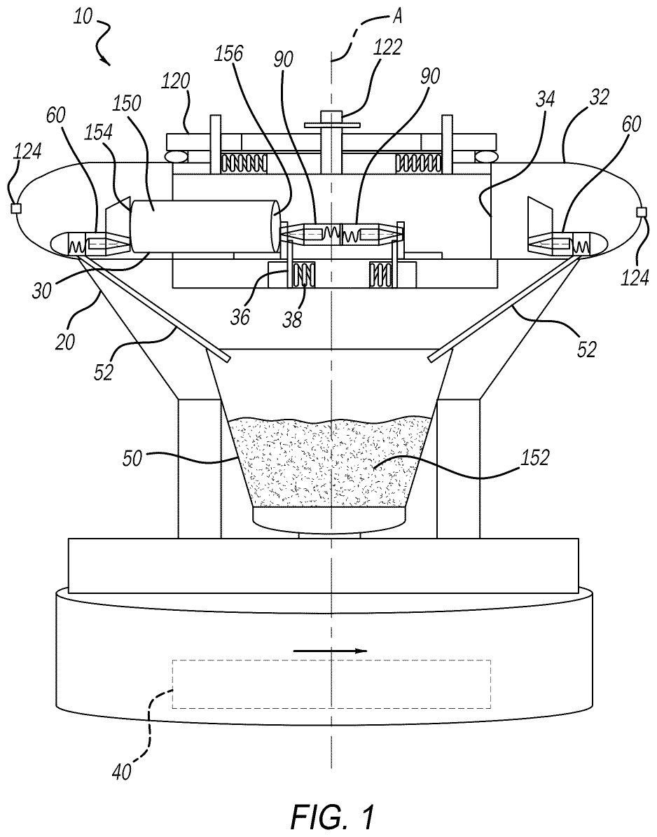

FIG. 1 illustrates a system 10 in accordance with the present disclosure for removing an electrolyte from a battery or a plurality of batteries simultaneously. The system 10 may be configured to accommodate any suitable type of battery, such as, but not limited to, a cylindrical battery or a prismatic battery. The batteries may be lithium-ion batteries or any other type of battery. The batteries may be configured for any suitable use, such as any suitable automotive or non-automotive use. With respect to automotive applications, the batteries may be configured to power a fully electric vehicle, a hybrid vehicle, or any other suitable vehicle. The system 10 is configured to remove the electrolyte for any suitable purpose, such as to recycle the battery and/or examine performance of the battery.

The system 10 generally includes a rotatable platform 20. A battery support 30 is configured to be rotated by the rotatable platform 20. The battery support 30 is configured to support any suitable battery, such as a battery 150. The battery 150 may be configured as a cylindrical battery cell, a prismatic battery cell, or any other suitable battery cell.

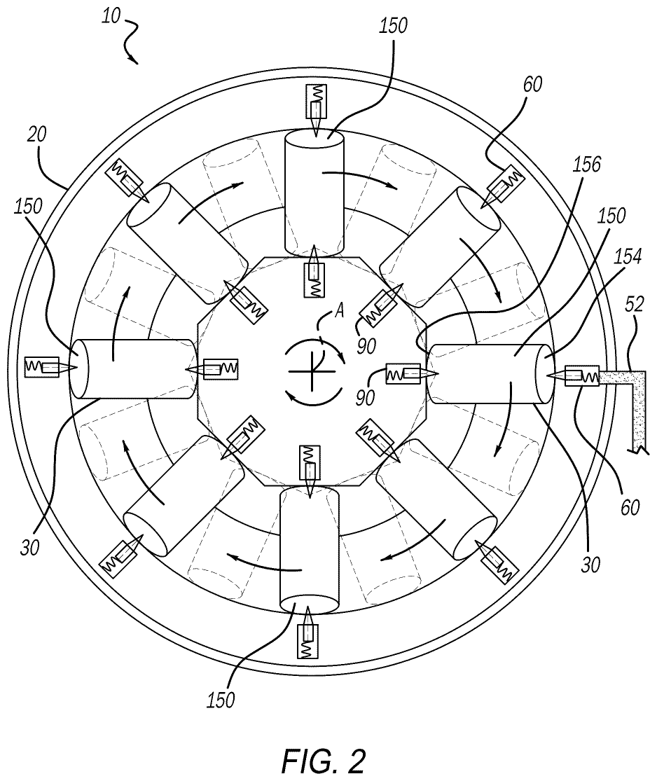

Any suitable number of the battery supports 30 may be included to support any suitable number of the batteries 150. For example, and as illustrated in FIG. 2, the system 10 may include a plurality of the battery supports 30 spaced apart in a circular manner around an axis of rotation A of the rotatable platform 20. The system 10 is thus configured to spin one or more of the batteries 150 about the axis of rotation A to drain, or otherwise remove, an electrolyte 152 from each one of the batteries 150 simultaneously. Centrifugal force generated as the rotatable platform 20 rotates facilitates removal of the electrolytes 152 from the batteries 150.

The rotatable platform 20 includes a housing 32. The housing 32 defines a receptacle 34. The battery supports 30 are within the receptacle 34 to support the batteries 150 within the receptacle 34. The system 10 may optionally include a cover 120. The cover 120 is configured to seal against the housing 32 over the receptacle 34 to seal the receptacle 34 closed. The cover 120 may be configured to provide an air-tight seal or any other suitable seal that will contain within the housing 32 the electrolyte and any other substances that may be released from the housing 32.

The cover 120 includes an inlet fitting 122. The inlet fitting 122 is configured as an inlet for the introduction of any suitable inert gas into the receptacle 34. The inert gas may be included to further lessen the possibility of any undesired reactions occurring as the electrolyte 152 is drained from the batteries 150. The housing 32 may further include one or more vents 124 to vent the receptacle 34.

The system 10 further includes a motor 40. The motor 40 may be any motor suitable to rotate the rotatable platform 20, and the batteries 150 mounted thereto, about the axis of rotation A. The motor 40 is configured to rotate the rotatable platform 20 at a speed sufficient to generate enough centrifugal force for draining the electrolyte 152 from the batteries 150 after the batteries 150 are punctured. For example, the motor 40 is configured to rotate the rotatable platform 20 at 200 RPM or greater. At 200 RPM, with a rotatable platform 20 having a nine-inch radius, the gravitational force on the batteries 150 will be about 10 G's.

The electrolyte 152 drained from the batteries 150 flows into a reservoir 50 by way of conduits 52. The conduits 52 are in fluid communication with the batteries 150 and the reservoir 50 so that the electrolyte 152 from each one of the batteries 150 may be deposited in the reservoir 50. Therefore, the system 10 is configured such that the reservoir 50 provides for a single collection area for the electrolyte 152 from each one of a plurality of the batteries 150.

An exemplary one of the battery supports 30 will now be described. The battery supports 30 are spaced apart about the longitudinal axis A. Each one of the battery supports 30 are the same, or substantially similar. Thus, the following description of one of the battery supports 30 applies to all of the battery supports 30.

With reference to FIG. 1, for example, the battery support 30 includes a flange 36. The flange 36 is in cooperation with a spring 38, or any other suitable biasing member. The flange 36 is configured to slide back and forth in a direction generally perpendicular to the axis of rotation A. The spring 38 is biased to push the flange 36 in a direction away from the axis of rotation A. The flange 36 is arranged and otherwise configured to abut an inboard end 156 of the battery 150 with respect to arrangement of the battery 150 on the rotatable platform 20. When the battery 150 is mounted to the battery support 30, the flange 36 is configured to apply a force to the battery 150 in a direction away from the longitudinal axis A.

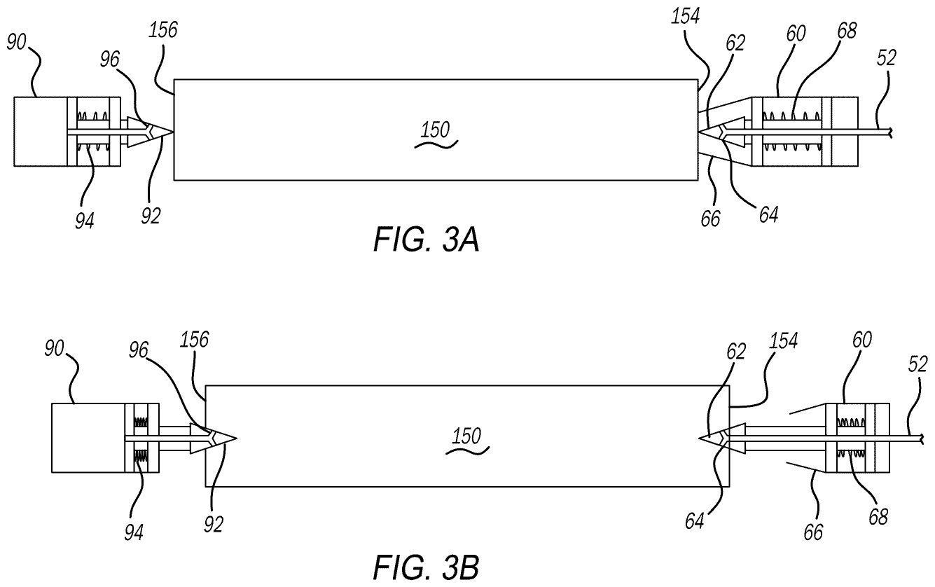

With continued reference to FIGS. 1 and 2, and additional reference to FIGS. 3A and 3B, the system 10 further includes an outboard impalement device 60 and an inboard impalement device 90. The battery support 30 is configured to support the battery 150 between the outboard impalement device 60 and the inboard impalement device 90. The outboard impalement device 60 and the inboard impalement device 90 are configured to puncture the battery 150 to drain the electrolyte 152 from the battery 150, as explained in detail herein. In general, as the motor 40 rotates the rotatable platform 20, centrifugal force moves the battery 150 outward against the outboard impalement device 60, which punctures the battery 150 causing the electrolyte 152 to drain out of the battery 150 and into the reservoir 50 by way of the conduit 52.

As illustrated in FIG. 2, the system 10 includes a plurality of the outboard impalement devices 60 and a plurality of inboard impalement devices 90. Each one of the plurality of outboard impalement devices 60 are the same or substantially similar. Each one of the plurality of the inboard impalement devices 90 are the same or substantially similar. Thus, the following description of an exemplary one of the outboard impalement devices 60 applies to all of the outboard impalement devices 60. And the following description of an exemplary one of the inboard impalement devices 90 applies to all of the inboard impalement devices 90.

During rotation of the rotatable platform 20, centrifugal force moves the battery 150 outward and away from the axis of rotation A. The flange 36 also moves outward from the axis of rotation A by centrifugal force to maintain contact with the battery 150 and support the battery 150. The inboard impalement device 90 moves with the flange 36, and punctures the inboard end 156 of the battery 150 to vent the battery 150, which facilitates drainage of the electrolyte 152 out of the battery 150 through the hole punctured therein by the outboard impalement device 60.

With reference to FIG. 3A, the battery 150 is arranged on the battery support 30 between the outboard impalement device 60 and the inboard impalement device 90. FIG. 3A illustrates the relative positions of the battery 150, the outboard impalement device 60, and the inboard impalement device 90 prior to rotation of the rotatable platform 20. To hold the battery 150 in place, the flange 36 abuts the inboard end 156 of the battery 150, and the spring 38 pushes the flange 36 outward away from the axis of rotation A in order to maintain contact between the flange 36 and the battery 150, as illustrated in FIG. 1.

With particular reference to FIG. 3A, the outboard impalement device 60 generally includes a tip 62 configured to puncture the battery 150. The tip 62 defines a channel 64, which extends generally from a distal end of the tip 62 to the conduit 52. The channel 64 is thus in fluid communication with the reservoir 50 by way of the conduit 52.

A sleeve 66 surrounds the tip 62. In the example of FIGS. 3A and 3B, the sleeve 66 is movable between an extended position (FIG. 3A) and retracted position (FIG. 3B). The outboard impalement device 60 includes a spring 68 or any other suitable biasing member configured to bias the sleeve 66 in the outward position of FIG. 3A. Upon rotation of the rotatable platform 20 by the motor 40, centrifugal force moves the battery 150 outward and away from the axis of rotation A. Centrifugal force also moves the sleeve 66 outward and away from the axis of rotation A, which results in compression of the spring 68, as illustrated in FIG. 3B.

Movement of the sleeve 66 outward as the rotational platform 20 rotates exposes the tip 62. As the rotational speed of the rotatable platform 20 increases, the centrifugal force generated acts further on the battery 150 and pushes the 150 against and onto the tip 62 with force sufficient to cause the battery 150 to be punctured by the tip 162. The tip 62 will enter the battery 150 far enough for the channel 64 to also enter the battery 150. The centrifugal force generated by rotation of the rotatable platform 20 will force the electrolyte 152 out of the battery 150, through the channel 64 of the tip 62, into the conduit 52, and ultimately to the reservoir 50. Thus, the outboard impalement device 60 of FIGS. 3A and 3B generally operates on the principals of gravity and centrifugal force moving the sleeve 66 from the extended position of FIG. 3A to the retracted position of FIG. 3B, to expose the tip 62, thereby allowing the tip 62 to puncture the battery 150.

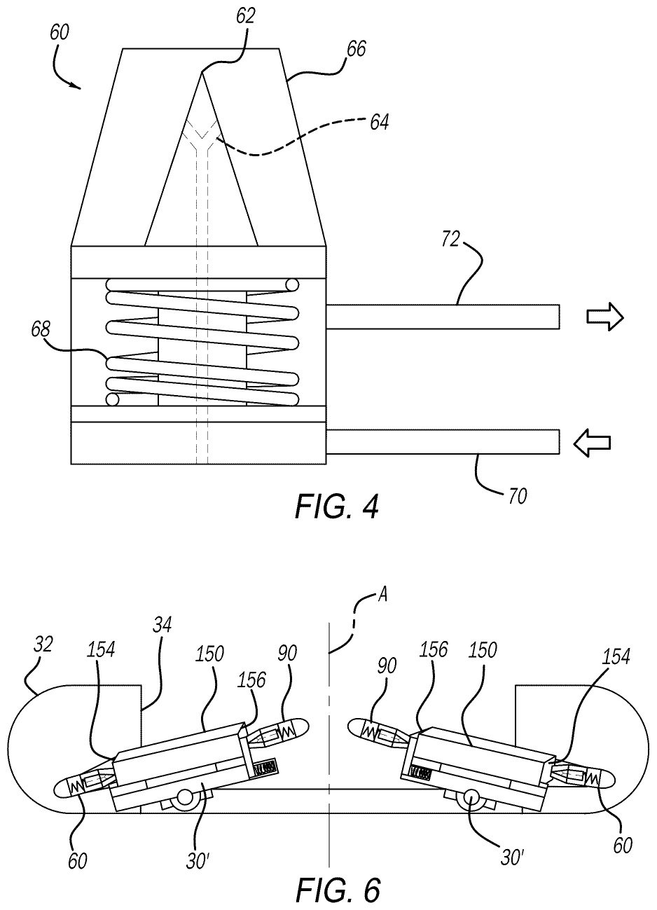

The outboard impalement device 60 may be configured in any other suitable manner to puncture the battery 150. For example, and as illustrated in FIG. 4, the outboard impalement device 60 may be configured as a pneumatic actuator. In the example of FIG. 4, the sleeve 66 remains stationary as the rotatable platform 20 is rotated by the motor 40. The tip 62 is movable between a retracted position as illustrated in FIG. 4, and an extended position in which the tip 62 protrudes outward from the sleeve, generally similar to the configuration of FIG. 3B, to puncture the battery 150. The tip 62 is movable from the retracted position to the extended position as a result of the introduction of gas through an inlet 70 to an area beneath the tip 62. As the gas flows through the inlet 70 into the outboard impalement device 60, the gas forces the tip 62 outward to the extended position, and into contact with the battery 150 to puncture the battery 150. To return the tip 62 to the retracted position of FIG. 4, the gas is withdrawn through the outlet 72. With the gas withdrawn, the spring 68 returns the tip 62 to the retracted position of FIG. 4. The gas may be air or any other suitable gas.

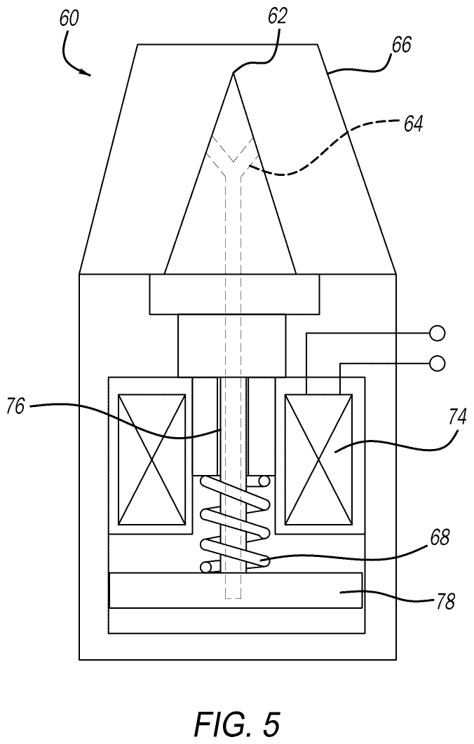

FIG. 5 illustrates another alternate configuration of the outboard impalement device 60. In the example of FIG. 5, the outboard impalement device 60 is configured with an electrical actuator. A coil 74 is included, which surrounds a rod 76 extending from the tip 62. The rod 76 extends to an armature 78, which is on a side of the coil 74 opposite to the tip 62. During rotation of the rotatable platform 20, current is directed through the coils 74 to energize the coils 74. This generates a magnetic force that pulls the armature 78 towards the coil 74, thereby moving the tip 62 from the retracted position of FIG. 5 to an extended position at which the tip 62 extends out from within the channel 64 (similar to that illustrated in FIG. 3B). As the tip 62 moves to the extended position, the tip 62 punctures the battery 150 at the outboard end 154 to drain the electrolyte 152 out from within the battery 150. After the electrolyte 152 has been drained into the reservoir 50, the motor 40 is configured to stop rotation of the rotatable platform 20. The coils 74 are then de-energized, which allows the spring 68 to return the tip 62 to the retracted position of FIG. 5.

With renewed reference to FIGS. 1, 2, 3A and 3B, the inboard impalement device 90 will now be described in detail. The inboard impalement device 90 includes a tip 92 and a spring 94, or any other suitable biasing member configured to bias the tip 92 in the retracted position of FIG. 3A. In response to rotation of the rotatable platform 20 by the motor 40, centrifugal force will draw the tip 92 away from the axis of rotation A and from the retracted position of FIG. 3A to an extended position of FIG. 3B.

The inboard impalement device 90 is configured such that the centrifugal force generated is sufficient to move the tip 92 from the retracted position of FIG. 3A to an extended position illustrated in FIG. 3B. As the tip 92 moves to the extended position, the centrifugal force is sufficient to cause the tip 92 to puncture the battery 150 at the inboard end 156 thereof, which is opposite to the outboard end 154 punctured by the outboard impalement device 60. The inboard impalement device 90 punctures a vent hole in the battery 150 to facilitate drainage of the electrolyte 152 out through the hole punctured by the outboard impalement device 60. The holes punctured by the inboard impalement device 90 also allows any inert gas added to the receptacle 34 to flow into the battery 150, thereby reducing any possibility of undesirable reactions therein. The vents 124 of the receptacle 34 further facilitate release of gas or fumes out from within the receptacle 34, which may be released from the batteries when the holes are punctured therein.

The inboard impalement device 90 may be configured to move from the retracted position of FIG. 3A to the extended position of FIG. 3B in response to gravitational forces, as illustrated in the configuration of FIGS. 3A and 3B. Alternatively, the inboard impalement device 90 may be configured as a pneumatic actuator similar to the configuration of FIG. 4, or an electronic actuator similar to the configuration of FIG. 5, or any other suitable type of actuation device.

In the configuration of FIG. 1, the battery support 30 is configured to support the battery 150 such that the battery 150 lies in a direction generally perpendicular to the axis of rotation A. FIG. 6 illustrates alternate battery supports in accordance with the present disclosure. In FIG. 6, a battery support 30′ is included. A plurality of battery supports 30′ may be included spaced apart about the axis of rotation A in place of, or in addition to, the battery supports 30. The following description of one of the battery supports 30′ applies to any additional number of battery supports 30′ that may be included with the rotatable platform 20.

The battery support 30′ is configured to support the battery 150 at an angle such that the outboard end 154 of the battery 150 is tilted downward relative to the inboard end 156. By tilting the outboard end 154 of the battery 150 downward as illustrated in FIG. 6, the battery support 30′ facilitates drainage of the electrolyte 152 out of the batteries 150 into the reservoir 50 by way of the conduits 52. The battery support 30′ may be configured to actuate to increase the tilt angle thereof in response to centrifugal force acting thereon during rotation of the rotatable platform 20. Increasing the tilt angle of the battery support 30′ may expediate drainage of the electrolytes 152 from the batteries 150.

The components of the system 10, such as the rotatable platform 20, the battery support 30, the housing 32, the reservoir 50, etc. may be formed in any suitable manner of any suitable materials. For example, some or all of the components of the system 10 may be formed by 3D printing. Any suitable 3D printing technology may be used.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

What is claimed is

1. A system configured to remove an electrolyte from a battery, the system comprising:
a rotatable platform;
a battery support configured to be rotated by the rotatable platform;
a motor configured to rotate the rotatable platform;
an impalement device adjacent to the battery support, the impalement device configured to puncture the battery seated on the battery support as the rotatable platform rotates to drain the electrolyte out of the battery by centrifugal force;
a reservoir configured to collect the electrolyte; and
a conduit in fluid communication with the impalement device and the reservoir to direct the electrolyte from the impalement device to the reservoir.

2. The system of claim 1, wherein:
the impalement device is a first impalement device, the system further comprising a second impalement device adjacent to the battery support and configured to puncture the battery seated on the battery support; and
the first impalement device and the second impalement device are configured to puncture opposite sides of the battery seated on the battery support.

3. The system of claim 2, wherein:
the rotatable platform includes a housing defining a receptacle, the battery support is within the receptacle; and
the system further includes a lid configured to cooperate with the housing to cover and seal the receptacle, the lid defining a gas inlet configured to direct gas into the receptacle.

4. The system of claim 3, wherein:
the first impalement device is outboard of the second impalement device such that the second impalement device is closer to an axial center of the rotatable platform than the first impalement device;
the first impalement device is configured to puncture a first end of the battery and the second impalement device configured to puncture a second end of the battery that is opposite to the first end; and
gas within the receptacle is free to flow into the battery through the second end of the battery when punctured by the second impalement device.

5. The system of claim 1, wherein the battery support is one of a plurality of battery supports spaced apart in a circle around an axis of rotation of the rotatable platform.

6. The system of claim 5, wherein the impalement device is one of a plurality of impalement devices each adjacent to a different one of the plurality of battery supports, each one of the plurality of impalement devices is configured to drain the electrolyte out of batteries seated in the plurality of battery supports; and
the conduit includes a plurality of conduits in fluid communication with the plurality of impalement devices to direct the electrolyte from the plurality of impalement devices to the reservoir.

7. The system of claim 1, wherein the battery support is configured to support one of a cylindrical battery cell and a prismatic battery cell.

8. The system of claim 1, wherein:
the impalement device includes a piercing tip; and
the battery support is configured to permit centrifugal force generated by rotation of the rotatable platform to move the battery into contact with the piercing tip such that the piercing tip punctures the battery.

9. The system of claim 8, wherein the piercing tip defines a channel in fluid communication with the conduit, an opening of the channel is configured to enter the battery when the piercing tip punctures the battery, the electrolyte flows through the channel of the piercing tip and into the conduit in response to centrifugal force generated as the rotatable platform rotates.

10. The system of claim 1, wherein:
the impalement device includes a piercing tip defining a channel in fluid communication with the reservoir by way of the conduit;
the impalement device includes an actuator configured to move the piercing tip into the battery to puncture the battery and drain the electrolyte out of the battery into the reservoir; and
the actuator is configured as one of an electric actuator and a pneumatic actuator.

11. The system of claim 1, wherein the battery support is configured to support the battery at an angle such that a distal end of the battery is tilted downward relative to a proximal end of the battery.

12. A system configured to remove an electrolyte from a battery, the system comprising:
a rotatable platform configured to rotate about an axis of rotation;
a battery support configured to be rotated by the rotatable platform;
a motor configured to rotate the rotatable platform;
an outboard impalement device adjacent to the battery support, the outboard impalement device configured to puncture an outboard end of the battery seated on the battery support as the rotatable platform rotates to drain the electrolyte out of the battery by centrifugal force;
an inboard impalement device opposite to the outboard impalement device, the battery support configured to support the battery between the outboard impalement device and the inboard impalement device, the inboard impalement device configured to puncture an inboard end of the battery as the rotatable platform rotates to vent the battery, the inboard impalement device is closer to the axis of rotation than the outboard impalement device;
a reservoir configured to collect the electrolyte; and
a conduit in fluid communication with the outboard impalement device and the reservoir to direct the electrolyte from the outboard impalement device to the reservoir.

13. The system of claim 12, wherein:
the rotatable platform includes a housing defining a receptacle, the battery support is within the receptacle;
the system further includes a lid configured to cooperate with the housing to cover and seal the receptacle, the lid defining a gas inlet configured to direct inert gas into the receptacle; and
inert gas within the receptacle is free to flow into the battery through the outboard end of the battery when punctured by the inboard impalement device.

14. The system of claim 12, wherein:
the battery support is one of a plurality of battery supports arranged in a circle around the axis of rotation of the rotatable platform; and
the outboard impalement device is one of a plurality of outboard impalement devices and the inboard impalement device is one of a plurality of inboard impalement devices, each one of the battery supports is arranged between one of the plurality of outboard impalement devices and one of the plurality of inboard impalement devices.

15. The system of claim 12, wherein the battery support is configured to support one of a cylindrical battery cell and a prismatic battery cell.

16. The system of claim 12, wherein:
the outboard impalement device includes a piercing tip defining a channel in fluid communication with the reservoir by way of the conduit;
the outboard impalement device includes an actuator configured to move the piercing tip into the battery to puncture the outboard end of the battery and drain the electrolyte out of the battery into the reservoir; and
the actuator is configured as one of an electric actuator and a pneumatic actuator.

17. The system of claim 12, wherein the battery support is configured to support the battery at an angle such that the outboard end of the battery is tilted downward relative to the inboard end of the battery.

18. A system configured to remove electrolytes from a plurality of batteries, the system comprising:
a rotatable platform configured to rotate about an axis of rotation;
a motor configured to rotate the rotatable platform;
a plurality of outboard impalement devices mounted to the rotatable platform and spaced apart around the axis of rotation, each one of the plurality of outboard impalement devices configured to puncture an outboard end one of the plurality of batteries as the rotatable platform rotates to drain the electrolyte out of the battery by centrifugal force;
a plurality of inboard impalement devices mounted to the rotatable platform and spaced apart around the axis of rotation, each one of the plurality of inboard impalement devices is opposite to a different one of the plurality of outboard impalement devices, each one of the plurality of inboard impalement devices is configured to puncture an inboard end one of the plurality of batteries to vent the plurality of batteries;
a reservoir configured to collect the electrolytes from each one of the plurality of batteries; and
a conduit system in fluid communication with each one of the outboard impalement devices and the reservoir to direct the electrolytes into the reservoir.

19. The system of claim 18, wherein each one of the outboard impalement devices includes a pointed tip configured to puncture the outboard end of the plurality of batteries, the pointed tip defines a channel in fluid communication with the conduit system to direct the electrolytes through the pointed tip and into the conduit system.

20. The system of claim 18, wherein:
the rotatable platform includes a housing defining a receptacle, each one of the plurality of outboard impalement devices and each one of the plurality of inboard impalement devices are within the receptacle; and
the system further includes a lid configured to cooperate with the housing to cover and seal the receptacle, the lid defining a gas inlet configured to direct inert gas into the receptacle.
